(19) United States
(12) Patent Application Publication
(10) Pub. No.: US 2005/0003158 A1
(43) Pub. Date: Jan. 6, 2005

(54) Weather strip and method of manufacturing the same

(75) Inventors: Hiroyuki Yamasa, Aichi (JP); Tadashi Sato, Aichi (JP); Katsura Sugiura, AIchi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOKAI KOGYO CO., LTD., Obu-city (JP)

(21) Appl. No.: 10/798,553

(22) Filed: Mar. 12, 2004

(30) Foreign Application Priority Data
Mar. 14, 2003 (JP) 2003-069820
Mar. 25, 2003 (JP) 2003-082858
Feb. 13, 2004 (JP) 2004-036940
Feb. 24, 2004 (JP) 2004-048007

(51) Int. Cl. B32B 1/00

(52) U.S. Cl. 428/143; 264/177.1

(57) ABSTRACT

A long weather strip includes an attach portion attachable along a window frame for vehicle, and a lip portion for sealing a glass window pane for vehicle. The lip portion protrudes from the attach portion toward the glass window pane to be in contact therewith. The glass window pane is movable within the window frame. The lip portion includes a rough surface portion pressed onto a face of the glass window pane and made of a molding material containing the following (a) to (c) : (a) olefin thermoplastic elastomer in which a content ratio of polyolefin resin as a hard segment is 50 mass % or more as a whole, (b) solid particles having an average particle diameter in a range from 1 to 100 μm, and (c) liquid lubricant. The rough surface portion has a surface formed in a corrugation state with a number of small projections with the solid particles.

### BACKGROUND OF THE INVENTION

1. Field of the Invention

The present invention relates to a weather strip mounted on the vehicle such as an automobile, and more particularly to a weather strip having the lip portions pressed onto a glass window pane for vehicle and its manufacturing method. Also, this invention relates to a weather strip assembly having such weather strip.

2. Background Art

One of the long members mounted on the vehicle such as an automobile is a glass run channel for guiding the movement of a glass window pane and concealing a gap between a mounted portion and the glass window pane. Generally, such glass run channel is mounted along a window frame of the vehicle, and has a groove for guiding a glass window pane in contact with a peripheral edge of the glass window pane movable within the window frame. Typically, the glass run channel comprises a base portion corresponding to a bottom of the groove, a pair of side wall portions rising from both ends of the base portion in the width direction and corresponding to the side walls of the groove, and a pair of lip portions overhanging inside the groove from the pair of side wall portions and resiliently pressed onto an outer surface and an inner surface (surface) of the glass window pane. The glass run channel of such a structure is produced by extruding an elastomer material such as a synthetic rubber mainly composed of ethylene-propylene-diene copolymer (EPDM), or olefinic or other thermoplastic elastomer (TPE).

The glass window pane movable in the groove of this glass run channel is moved (slid (e.g., ascended or descended) while being pressed onto the surfaces of the lip portions. Thus, to reduce a sliding resistance in moving the glass window pane, it is well known to provide a layer having a small friction coefficient on a sliding face of the lip portions. For example, it has been proposed to co-extrude a sliding material such as polyethylene resin, to provide a coating film of urethane resin, and contain particulate lubricant in the coating film (e.g., refer to JP-A-2000-52780, JP-A-10-166868, and JP-A-7-150074).

By the way, in recent years, the duration of service of the vehicle tends to be longer, and correspondingly, there is a desire for maintaining the performance of glass run channel and other vehicle components for the long time. For example, in the case of the glass run channel, the sliding resistance in moving the glass window pane is prone to change (typically increase) due to a long time use (i.e., if the number of opening or closing the glass window pane is increased) . Therefore, it is demanded that the sliding resistance is prevented from increasing for the long time. However, the techniques as disclosed in the above official gazettes had a room for improvement, from the viewpoint of persistency of preventing the sliding resistance from increasing. For example, when the number of sliding with the glass window pane is relatively small, the sliding resistance is low, but when the number of sliding is several thousands or more, the sliding resistance is likely to increase.

### SUMMARY OF THE INVENTION

Thus, it is an object of the invention to provide a glass run channel having higher persistency of keeping the sliding resistance with the glass window pane from increasing, and its manufacturing method. It is another object of the invention to provide a glass run channel assembly comprising such glass run channel.

That is, the invention provides a long weather strip including an attach portion attachable along a window frame for vehicle and a lip portion for sealing a glass window pane for vehicle, the lip portion protruding from the attach portion toward the glass window pane to be in contact therewith, the glass window pane movable within the window frame. And the lip portion has a rough surface portion made of a molding material composed of (a) olefin thermoplastic elastomer in which a content ratio of polyolefin resin as a hard segment is 50 mass % or more as a whole, (b) solid particles having an average particle diameter in a range from 1 to 100 μm, and (c) liquid lubricant at room temperatures, at least in a part of the lip portion pressed onto a face of the glass window pane. The rough surface portion has a surface formed in a corrugation state, and is formed with a number of small projections with the solid particles on a corrugated face of the rough surface portion.

According to the invention, the rough surface portion having the above composition and contour (corrugated face formed with a number of small projections) is provided in a part of the lip portion pressed onto the glass window pane, whereby there is the effect that the sliding resistance with the surface of the glass window pane is low and the persistency (durability) of preventing the sliding resistance from increasing is excellent. For example, even if the number of moving the glass window pane is increased due to long time use, the sliding resistance of the glass window pane is kept at a target value or less.

Preferably, the weather strip further includes a groove for guiding the glass window pane in contact with a peripheral edge thereof. The groove includes a base portion making up a bottom of the groove, and side wall portions rising from both ends of the base portion in the width direction and making up the side walls of the groove. The resin main portion includes the base portion, the side wall portions, and the lip portions integrally.

Preferably, the rough surface portion is further provided on a surface inside the groove in the base portion.

The surface inside the groove in the base portion may produce a sliding resistance by being pressed onto the end face of the glass window pane. The sliding resistance arises as a part of the sliding resistance in moving the glass window pane when the weather strip is disposed almost parallel to the moving direction of the edge of the glass window pane, or arises as a part of the sliding resistance just before stopping movement of the glass window pane when the weather strip is disposed almost orthogonal to the moving direction of the edge of the glass window pane. Accordingly, if the rough surface portion is provided in such portion, the sliding resistance is further reduced, and a state of low sliding resistance is maintained excellently for the long time. In this way, the effect of the invention may be enhanced.

Preferably, the rough surface portion is further provided on at least one of the surfaces inside the groove in the side wall portion and a back face of the lip portion opposite the surface.

According to the invention, if the lip portions are resiliently deformed by the moving glass window pane, and approaches the side wall portion, the lip portions are pressed against the side wall portions owing to accumulation of an error (so-called construction error) in the shape between the window frame and the weather strip and an error in the locus of the moving glass window pane. At this time, the back face of the lip portion is contact with an inner side face of the side wall portion. If the rough surface portion is provided in at least one of the lip portion and the side wall portion, an adhesion between the inner side face of the side wall portion and the back face of the lip portion is decreased.

Further, if the glass window pane is moved back to get out of the groove, the lip portions pressed against the side wall portions tend to restore the original shape. At this time, the back face of the lip portion adheres to the inner side face of the side wall portion, the noise (peeling sound “pee”) may be produced when the lip portion is separated away from the side wall portion. When the rough surface portion is provided in at least one of the lip portion and the side wall portion, there is the effect of preventing such a phenomenon from occurring.

Preferably, a hard segment composing the olefin thermoplastic elastomer is polypropylene resin, and a soft segment is ethylene-propylene-diene copolymer. The invention may provide the effect that the rough surface portion having the above contour is easily formed, in addition to the above effects

Preferably, the lubricant is silicone oil. According to the invention, the rough surface portion having the above contour is easily formed at the time of extrusion molding the rough surface portion.

Preferably, the solid particle is a material not melted at the time of molding the rough surface portion. Accordingly, the rough surface portion with the shape (preferably spherical shape) of particle held is molded because the solid particles are not molten at the time of molding the rough surface portion, thereby providing a desired sliding ability.

Preferably, the solid particle is one or two kinds of spherical particle selected from a group consisting of silicone resin particle, glass bead, glass balloon, silica particle, polymethyl methacrylate resin particle, and polyether-ether-ketone resin particle. Accordingly, the rough surface portion having the above contour is easily formed.

Preferably, the rough surface portion contains 1 to 20 mass parts of the solid particles and 1 to 20 mass parts of the lubricant to 100 mass parts of the olefin thermoplastic elastomer. Accordingly, the rough surface portion having the above contour is easily formed.

Preferably, the weather strip includes a long resin main portion made of a molding material containing olefin thermoplastic elastomer having a lower hardness than the olefin thermoplastic elastomer of (a), in which the rough surface portion is provided at least in a part on the surface of the resin main portion. The term “hardness” as used herein typically means a durometer hardness according to JIS K 7215. Also, the term “resin” as used in the term “resin main portion” is a concept covering so-called elastomer materials such as olefin and other thermoplastic elastomers (TPE).

In this way, the rough surface portion formed of a relatively hard elastomer is provided at least in a part on the surface of the resin main portion formed of a relatively soft (low hardness) elastomer, the rough surface portion can be pressed onto the glass window pane at adequate resilient force due to resiliency of the resin main portion. Accordingly, the invention provides the effect that the sliding resistance and the resilient force are easily balanced and made consistent. The above configuration takes effect remarkably especially when it is applied to the lip portions.

Preferably, the weather strip includes a glass run channel having the resin main portion; and the resin main portion includes the base portion, the side wall portions, and the lip portions integrally.

According to the invention, the base portion, the side wall portions, and the lip portions are easily molded integrally by extrusion molding the resin. Accordingly, the glass run channel is easily produced.

Preferably, the resin main portion and the rough surface portion have miscibility, and are welded at a boundary therebetween. In this way, the rough surface portion and the resin main portion having miscibility are easily joined by welding at the time of co-extrusion molding. Accordingly, the rough surface portion is not peeled and the glass run channel has excellent durability.

Preferably, the rough surface portion is formed in a layer, being from 10 to 100 μm in an average thickness. Typically, the rough surface portion is formed in a layer having almost uniform thickness. Accordingly, the rough surface portion having the above contour is easily formed.

Preferably, the rough surface portion has a corrugated face that is formed with a plurality of line-like protruded portions extending longitudinally and being spaced at an interval in the width direction, the small projections being formed on the surface of the protruded portion.

With such configuration, the tip (top portion) of the protruded portion mainly makes contact with the glass window pane, thereby reducing a substantial contact area between the rough surface portion and the glass window pane. Accordingly, the sliding resistance is reduced. Also, between the protruded portions, the rough surface portion is thinner than the protruded portion, easily following the deformation of the resin main portion, whereby there is the effect that a portion provided with the rough surface portion is resiliently deformed easily and appropriately.

Preferably, the rough surface portion is formed like a longitudinally extending line, and a plurality of line rough surface portions are spaced at an interval in the width direction.

According to the invention, a substantial contact area between the rough surface portion and the glass window pane is reduced. Accordingly, the sliding resistance is reduced. Also, a portion without the rough surface portion, or the resin main portion that is more flexible than the rough surface portion, absorbs the deformation, whereby there is the effect that the glass run channel having the rough surface portion is resiliently deformed easily and appropriately.

Preferably, the weather strip is formed as a belt molding that is attached along an edge of the window frame.

Also, this invention provides a weather strip assembly including a weather strip in this specification.

That is, the invention provides a weather strip assembly for vehicle including: at least two long weather strips for vehicle mounted along a window frame for vehicle and having a groove for guiding a glass window pane in contact with a peripheral edge of the glass window pane movable within the window frame; and a joint portion for connecting the longitudinal terminals of the weather strips. The weather strip includes a base portion making up a bottom of the groove, the side wall portions rising from both ends of the base portion in the width direction and making up the side walls of the groove, and the lip portions overhanging inside the groove from the side wall portions and resiliently pressed onto a surface of the glass window pane. At least one of the weather strips having a rough surface portion made of a molding material containing the following (a) to (c): (a) olefin thermoplastic elastomer in which a content ratio of polyolefin resin as a hard segment is 50 mass % or more as a whole, (b) solid particles having an average particle diameter in a range from 1 to 100 μm, and (c) liquid lubricant at room temperatures, the rough surface portion is provided in apart of the lip portion pressed onto the surface of the glass window pane. The rough surface portion has a surface formed in a corrugation state, and is formed with a number of small projections with the solid particles on a corrugated face of the rough surface portion.

According to the invention, at least one of the weather strips for forming the assembly is provided with the rough surface portion having the above composition and contour (corrugated face formed with a number of small projections) in a part of the lip portion for the glass run channel to be pressed onto the glass window pane. Accordingly, the sliding resistance of the glass window pane is reduced, and the persistency (durability) of keeping the sliding resistance from increasing is excellent.

A typical example of this weather strip assembly may employ the weather strip.

Preferably, the at least one of the weather strips is a glass run channel further including a rough surface portion in at least one part of (a) a surface inside the groove in the base portion, (b) a surface inside the groove in the side wall portion, and (c) a back face of the lip portion opposed to the surface inside the groove in the side wall portion.

According to the invention, the rough surface portion is provided on the surface inside the groove in the base portion of the glass run channel, thereby further enhancing the effect of the assembly. Also, the rough surface portion is provided on at least one of the surface inside the groove in the side wall portion, and the back face of the lip portion opposed to the surface inside the groove in the side wall portion, thereby providing at least one of the effects of not increasing the sliding resistance even if the edge of the glass window pane slidingly contacts the surface in the side wall portion, enhancing the shape restorability of the lip portion, and preventing a strange sound from arising when the lip portion is separated away from the side wall portion.

Moreover, the invention provides a method for manufacturing a weather strip in the following way.

That is, the invention provides a method for manufacturing a long weather strip for vehicle, wherein the weather strip includes: an attach portion attachable along a window frame for vehicle, and a lip portion for sealing a glass window pane for vehicle, the lip portion protruding from the attach portion toward the glass window pane to be in contact therewith, the glass window pane movable within the window frame; and the lip portion has a rough surface portion provided at least in a part of the lip portion pressed onto a face of the glass window pane; the method including: heating and melting a molding material for formation of the rough surface portion, the molding material containing the following (a) to (c); (a) olefin thermoplastic elastomer in which a content ratio of polyolefin resin as hard segment is 50 mass % or more as a whole, (b) solid particles having an average particle diameter in a range from 1 to 100 μm, and (c) liquid lubricant at room temperatures; and extruding the melted molding material from a resin extrusion mold, thereby forming the rough surface portion having a surface formed in a corrugation state and formed with a number of small projections with the solid particles on a corrugated face thereof.

According to the invention, the rough surface portion having the predetermined contour (corrugated face formed with a number of small projections) is produced by a simple method for heating and melting, and extruding the molding material for formation of rough surface portion having a predetermined composition. A typical example of the weather strip preferably manufactured by the above method is the weather strip according to any one of the claims.

Preferably, the rough surface portion is formed at least in a part on the surface of the long resin main portion; the step of heating and melting includes heating and melting the molding material for formation of the rough surface portion and a molding material for formation of the resin main portion; and the step of extruding includes extruding the molten molding materials from the resin extrusion mold at the same time, thereby forming the resin main portion and the rough surface portion.

According to the invention, the weather strip formed with the rough surface portion at least in a part on the surface of the resin main portion is easily manufactured through one extrusion process employing one extrusion mold. This manufacturing method is suitably applied when the molding material for formation of rough surface portion and the molding material for formation of resin main portion have the equal or almost equal molding temperatures. The weather strip may be manufactured by melting the molding material for formation of rough surface portion and the molding material for formation of resin main portion and extruding the molten molding materials, together with the long preformed main portion (e.g., resin main portion made of the molding material having different composition from the above composition, or metallic main portion) from the resin extrusion mold.

Preferably, the extruding step includes extruding the molten molding material for formation of the rough surface together with a long preformed main portion from the resin extrusion mold, thereby forming the rough surface portion at least in a part on the surface of the long preformed main portion.

According to the invention, the rough surface portion is easily formed at least in a part on the surface of any long main portion. This manufacturing method is suitably applied when the molding material for formation of the long main portion (e.g., the resin main portion) and the molding material for formation of rough surface portion have greatly different molding temperatures.

### BRIEF DESCRIPTION OF THE DRAWINGS

The present invention may be more readily described with reference to the accompanying drawings:

FIG. 1 is a side view showing an automobile in a state where a glass run channel assembly in an example is mounted on a front door panel.

FIG. 2 is a cross-sectional view of a glass run channel according to a first example, taken along the line II-II in FIG. 1.

FIG. 3 is a cross-sectional view of the glass run channel according to the first example, taken along the line III-III in FIG. 1.

FIG. 4 is a cross-sectional view of the glass run channel according to the first example, taken along the line IV-IV in FIG. 1.

FIG. 5 is a perspective view, partially broken away, showing a state where two glass run channels are connected at a joint portion.

FIG. 6 is an explanatory view schematically showing a method for measuring the sliding resistance.

FIG. 7 is a cross-sectional view showing the essence of a glass run channel according to a second example.

FIG. 8 is a cross-sectional view showing the essence of a glass run channel according to a third example.

FIG. 9 is a cross-sectional view showing the essence of the glass run channel according to the third example.

FIG. 10 is a schematic cross-sectional view showing the contour of a rough surface portion.

FIG. 11 is a schematic cross-sectional view showing the contour of the rough surface portion.

FIG. 12 is an explanatory view schematically showing one manufacturing example of the glass run channel according to the invention.

FIG. 13 is an explanatory view schematically showing one manufacturing example of the glass run channel according to the invention.

FIG. 14 is a characteristic diagram showing the measurement results of the sliding resistance.

FIG. 15 is a characteristic diagram showing the measurement results of the sliding resistance.

FIG. 16 is a cross-sectional view showing a configuration of a belt molding.

### DETAILED DESCRIPTION OF THE PREFERRED EMBODIMENTS

The preferred embodiments of the present invention will be described below. In this specification, the requirements for carrying out the invention other than those specifically referred to (e.g., features on the construction and/or composition of a glass run channel according to this invention) may be grasped as the design requirements for a person skilled in the art based on the prior arts. This invention may be practiced based on the matters as disclosed in this specification and drawings and the common general technical knowledge in the relevant field.

The glass run channel of the invention is mounted along a window frame of the vehicle and has a groove for guiding a glass window pane in contact with a peripheral edge of the glass window pane movable within the window frame, comprising a base portion, a side wall portion, and a lip portion, in which a predetermined rough surface portion is provided at least in a part of the lip portion pressed onto the glass window pane face. The glass run channel of the invention may not be limited in the respects of the other structure or additional elements.

This glass run channel is mounted on the window frame (but not limited to that provided on a door panel) of the vehicle such as an automobile. The outside shape of the glass run channel or the shape of a main portion (including a cross-sectional shape of the groove) may be determined to adapt to the shape of a mount portion on the window side or the glass window pane (peripheral edge).

A rough surface portion provided for the glass run channel according to this invention will be described below. This rough surface portion is composed of (a) olefin thermoplastic elastomer, (b) solid particles, and (c) a molding material containing a lubricant (molding material for formation of the rough surface portion, or also referred to as a “rough surface portion molding material”).

The constituent (a) is olefin thermoplastic elastomer containing polyolefin resin as hard segment. This polyolefin resin (olefin constituent) maybe polyethylene, polypropylene or poly-1-pentene. Among others, polyethylene and polypropylene are preferable, and polypropylene is more preferable. Also, a soft segment (elastomer constituent) composing this olefin thermoplastic elastomer may be ethylene-propylene copolymer (EPM) or ethylene-propylene-diene copolymer (EPDM). Among others, EPDM is particularly preferable. The hard segment may contain two or more kinds of polymers, and the soft segment may also contain them. Particularly, olefin thermoplastic elastomer in which the hard segment is polypropylene and the soft segment is EPM or EPDM is preferably employed.

A percentage of hard segment (olefin constituent) contained in the olefin thermoplastic elastomer ((a) constituent) is preferably 50 mass % or more (typically 50 to 90 mass %) of the entire elastomer ((a) constituent), and more preferably 60 mass % or more (typically 60 to 85 mass %). For example, olefin thermoplastic elastomer that blends, at a mass ratio, 60 to 85 parts (more preferably 65 to 80 parts) of polypropylene, 10 to 30 parts (more preferably 15 to 25 parts) of EPDM, an appropriate amount (e.g., 5 to 30 parts, preferably 10 to 20 parts) of a softening agent is suitable as the (a) constituent. The softening agent may be a process oil (typically paraffin or naphthene base), for example. An appropriate amount of cross-linking agent (organic peroxide) may be added, as needed.

The hardness of olefin thermoplastic elastomer ((a) constituent) composing the rough surface portion is preferably 40 degrees (HDD 40) or more (typically 40 to 70 degrees) in a durometer hardness D according to JIS K 7215, more preferably 50 degrees or more (typically 50 to 65 degrees), and most preferably 55 degrees or more (typically 55 to 60 degrees). If the hardness of olefin thermoplastic elastomer composing the rough surface portion is too low, the effect of reducing and/or maintaining the sliding resistance may be lower. Also, the adhesion with a resin main portion may be increased.

The solid particles as the (b) constituent are kept in the solid state at typical molding temperatures of the molding material (rough surface portion molding material). The solid particles made of a material that is substantially not molten during formation of the rough surface portion (i.e., at the molding temperatures of the rough surface portion) may be appropriately selected according to the fabrication conditions of the glass run channel. An average particle diameter of solid particles is preferably in a range from 1 to 100 μm, and more preferably in a range from 3 to 20 μm. Also, it is preferred that the solid particles having an average particle diameter from 3 to 15 μm and the solid particles having an average particle diameter from 25 to 100 μm may be employed together. The particle shape of solid particles is preferably almost spherical. The solid particles may be mainly composed of a ceramics material (oxide such as silica, alumina, zirconia or titania, carbide such as silicon carbide or boron carbide, nitride such as silicon nitride or boron nitride), a metal material (molybdenum particles), or an organic material (polyamide resin or fluororesin, polymethacrylate resin, polyether-ether-ketone resin), or a composite material thereof. Besides, the solid particles may be mainly composed of silicon resin, graphite, molybdenum disulfide, calcium carbonate, calcium silicate, clay, kaolin, diatomite, mica, barium sulfate, aluminum sulfate, calcium sulfate, or basic magnesium carbonate. Among them, one or more kinds may be employed. The (b) constituent in this invention may be preferably solid particles mainly composed of silica or silicon resin. The so-called spherical silicon resin particles, spherical glass beads, spherical glass balloons (hollow glass particles) or spherical silica particles may be preferably employed. Another example of solid particles preferably employed may be relatively hard resin particles such as polymethyl methacrylate resin particles or polyether-ether-ketone resin particles.

The lubricant as the constituent (c) is liquid at ordinary temperatures, and may be silicon oil (polydimethyl silicon), for example.

In a preferred embodiment of the invention, the percentage of constituents (a) and (b) contained in the rough surface portion is a mass ratio of 1 to 20 parts (preferably 2 to 15 parts) of (b) constituent to 100 parts of (a) constituent. Also, the percentage of constituents (a) and (c) contained in the rough surface portion is a mass ratio of 1 to 20 parts (preferably 2 to 10 parts) of (c) constituent to 100 parts of (a) constituent. The rough surface portion has preferably a composition in which 1 to 20 parts (preferably 2 to 15 parts) of (b) constituent and 1 to 20 parts (preferably 2 to 10 parts) of (c) constituent are contained in 100 parts of (a) constituent. With such composition, the rough surface portion having a surface state (corrugated face formed with a number of small projections) is easily formed. As a result, the glass run channel is low in sliding resistance and has excellent persistency of preventing the sliding resistance from increasing. Moreover, the liquid lubricant such as silicon oil may be preferably a blend of components having different molecular weights. Thereby, a lubricant having smaller molecular weight exudes on the surface of the rough surface portion earlier than a lubricant having larger molecular weight, and then the lubricant having larger molecular weight exudes, whereby the sliding resistance is prevented from increasing for the long time, employing a difference in the exuding time.

The rough surface portion constituting the glass run channel of this invention may contain thermoplastic resins other than the hard segment contained in the (a) constituent. Suitable examples of such thermoplastic resins may include olefin resins such as ultra high molecular weight polyethylene, high density polyethylene, medium density polyethylene, low density polyethylene, linear low density polyethylene, and ultra low density polyethylene, polybutene, ethylene-α-olefin copolymer, propylene-α-olefin copolymer, ethylene-vinyl acetate copolymer, hard or soft polyvinyl chloride (PVC), ABS resin, polyvinyl alcohol, butadiene rubber, isoprene rubber, butyl rubber, and fluoro rubber. From the viewpoint of maintaining or improving the glass sliding ability, wear resistance and impact resistance, an appropriate amount (preferably 20 to 60 parts to 100 parts of (a) constituent at a mass ratio) of high molecular weight polyethylene or high density polyethylene should be added. Addition of high molecular weight polyethylene is particularly preferable.

Also, from the viewpoint of maintaining or improving the sliding ability with glass, other materials contained in the rough surface portion may be acrylic silicon resin and fatty acid compound. Acrylic silicon resin is preferably contained at a mass ratio of 10 parts or less (typically 1 to 10 parts) to 100 parts of (a) constituent. Also, fatty acid compound is preferably fatty acid amides that are solid at ordinary temperatures and liquid at molding temperatures, such as erucic acid amide, oleic acid amide and stearic acid amide. Fatty acid compound is preferably contained at a mass ratio of 5 parts or less (typically 0.5 to 5 parts) to 100 parts of (a) constituent. The rough surface portion of the invention may contain other auxiliary constituents as one or more kinds of general additives, such as antioxidant, light stabilizer, UV-absorber, plasticiser, lubricant, colorant and flame retardant.

The detailed contour of the rough surface portion made of the molding material having the above composition will be now described.

The rough surface portion provided for the glass run channel of the invention has a surface formed in a corrugation state. The corrugation state of the rough surface portion is preferably almost uniform in the longitudinal direction of the rough surface portion. It is more preferable that the corrugation state is almost uniform in both the longitudinal direction and the width direction (orthogonal to the longitudinal direction) of the rough surface portion. The almost uniform corrugation state as used herein means that there is no remarkable difference between one part and the other of the rough surface portion in one or more characteristics of the average height of corrugation, the compactness (density) of corrugation, and the shape of corrugation.

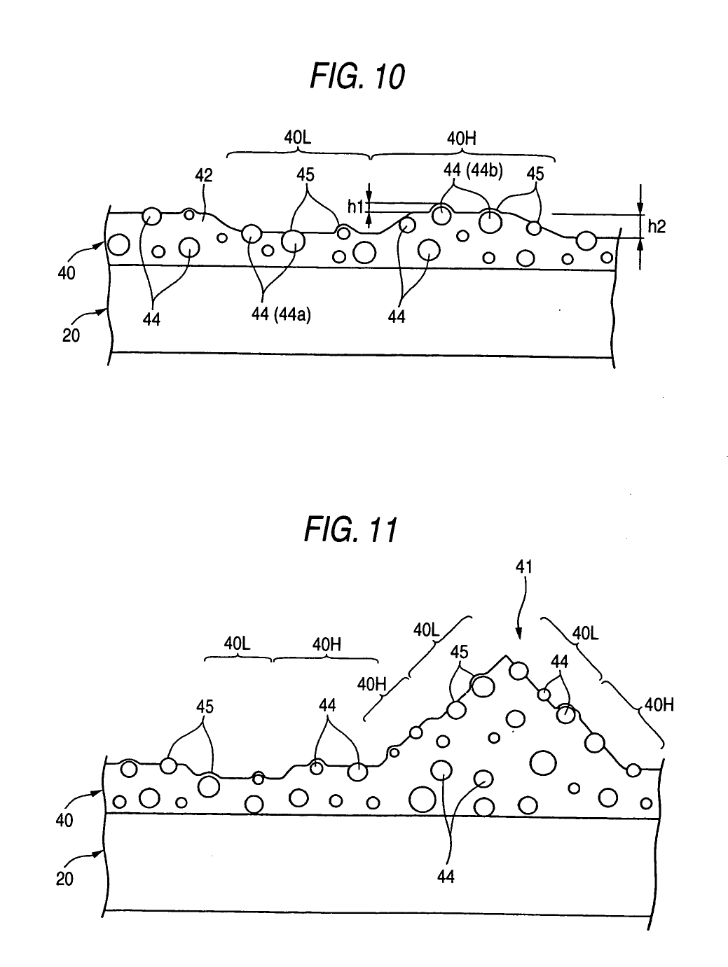

FIG. 10 is a typical cross-sectional view showing a surface state of the rough surface portion according to the invention. In FIG. 10, a rough surface portion 40 is formed in a predetermined part on the surface of a resin main portion making up the lip portion. As illustrated, the surface of this rough surface portion 40 is formed in a corrugation state where a relatively high portion 40H and a relatively low portion 40L are mixed.

And a number of small projections 45 are formed on the corrugated face in the corrugation state. These small projections 45 are protrusions formed on the corrugated face, which are caused by existence of solid particles 44 contained in the rough surface portion 40. The surface of solid particles 44 contributing to formation of small projections 45 may be exposed from a matrix resin 42 (continuous phase with solid particles 44 dispersed) constituting the rough surface portion 40, like solid particle as indicated by reference sign 44a, or unexposed from the matrix resin 42, like solid particle as indicated by reference sign 44b. As illustrated, the solid particles 44a exposed from the matrix resin 42 and the solid particles 44b unexposed therefrom may be mixed. These small projections 45 are preferably formed almost uniformly in both the longitudinal direction and the width direction (orthogonal to the longitudinal direction) of the rough surface portion 40. Herein, the small projections formed almost uniformly means that there is no remarkable difference between one part and the other of the rough surface portion (corrugated face) in one or more characteristics of the average height of small projections and the compactness of small projections.

The height of small projections 45 (height of protrusions from the surrounding corrugated face as indicated by sign h1 in FIG. 10) is normally, as its average value, the height corresponding to 10 to 300% of the average particle diameter of solid particles 44 contained in the rough surface portion 40, and preferably the height corresponding to 25 to 200% (more preferably 50 to 150%). Also, the height of corrugation on the corrugated face (a difference between relatively high portion 40H and relatively low portion 40L as indicated by sign h2 in FIG. 10) is normally, as its average value, preferably double or more the average height of small projections 45, and more preferably five times or more.

This contour of the rough surface portion is typically realized by extruding the molding material (rough surface portion molding material) having the above specific composition by ordinary methods, for example. That is, when the rough surface portion molding material is extruded, the rough surface portion having the above contour (corrugated face formed with small projections) is formed, along with the extrusion, without needing any after-treatment for appending the corrugation shape on the surface.

This rough surface portion may be provided in the almost entire or partial range of the portion pressed onto the glass window pane face in the lip portion. Usually, the rough surface portion is preferably provided in the almost entire range of the portion pressed onto the glass window pane face. Also, the rough surface portion may be provided continuously in this portion longitudinally, or a plurality of rough surface portions maybe provided intermittently at certain intervals. The rough surface portion may be provided in a predetermined portion on the surface of the lip portion, or round the surface of the lip portion to the back face. Preferably, the rough surface portion is provided in the predetermined portion on the surface of the lip portion. Or the lip portion itself (entire lip portion) may be made up by the rough surface portion, and further the base portion or side wall portion may be almost entirely made up by the rough surface portion. The position at which the rough surface portion is provided, and the shape and size of the rough surface portion may be fixed over the longitudinal direction of the glass run channel, or may be different depending on the region.

In the glass run channel according to the preferred embodiment of the invention, the lip portion has a long resin main portion, and the rough surface portion is provided at least partially on the surface of the resin main portion. The rough surface portion is preferably provided at least in the portion pressed onto the glass window pane face. This long resin main portion is preferably mainly composed of elastomer. The elastomer (high molecular compound exhibiting the rubber elasticity at room temperatures) composing the resin main portion may be thermoplastic elastomer, thermosetting elastomer, EPM, EPDM, or a synthetic rubber such as styrene-butadiene rubber (SBR). Among others, thermoplastic elastomers such as olefin thermoplastic elastomer (TPO), styrene thermoplastic elastomer (SBC), urethane thermoplastic elastomer (TPU), and polyamide thermoplastic elastomer (TPAE) are suitable. Particularly, olefin thermoplastic elastomer is preferable from the respects of cost, availability and extrusion molding.

Olefin thermoplastic elastomer composing the resin main portion may be similar to olefin thermoplastic elastomer of (a) constituent composing the rough surface portion. Herein, olefin thermoplastic elastomer of (a) constituent and olefin thermoplastic elastomer composing the resin main portion preferably have common ingredients in at least one (preferably both) of the hard segment and the soft segment. Thereby, the resin main portion and the rough surface portion are joined (typically thermally welded) excellently. For example, these olefin thermoplastic elastomers have preferably the hard segment of polypropylene; and the soft segment of EPDM.

Between olefin thermoplastic elastomer of (a) constituent and olefin thermoplastic elastomer composing the resin main portion, a content percentage of hard segment (olefin constituent) occupied in the whole of each elastomer may be equivalent or different. Usually, it is preferable that the content percentage of hard segment occupied in the entire olefin thermoplastic elastomer composing the resin main portion is lower than the content percentage of hard segment occupied in the entire olefin thermoplastic elastomer ((a) constituent) composing the rough surface portion. Also, it is preferable that the content percentage of softening agent (typically process oil) occupied in the entire olefin thermoplastic elastomer composing the resin main portion is higher than the content percentage of softening agent occupied in the entire olefin thermoplastic elastomer ((a) constituent) composing the rough surface portion. For example, a suitable example of olefin thermoplastic elastomer composing the resin main portion may be a blend of, at a mass ratio, 5 to 45 parts (preferably 10 to 35 parts, more preferably 20 to 30 parts) of polypropylene, 20 to 60 parts (preferably 30 to 50 parts) of EPDM, and an appropriate amount (preferably 20 to 50 parts, more preferably 30 to 40 parts) of softening agent. An appropriate amount of cross-linking agent (organic peroxide) maybe added, as needed.

The hardness of elastomer (preferably olefin thermoplastic elastomer) composing the resin main portion is preferably 90 degrees (HDA 90) or less (typically 50 to 90 degrees) in a durometer hardness A according to JIS K 7215, and more preferably 80 degrees or less (typically 60 to 80 degrees). When the resin main portion is composed of elastomer having a hardness in the above range, the rough surface portion is pressed onto the glass window pane face at an adequate resilient force (e.g., resilient force capable of retaining the sealing property without increasing the sliding resistance with the glass window pane excessively) due to its resiliency. Because the sliding resistance and the resilient force is easily balanced, the elastomer composing the resin main portion has preferably a lower durometer hardness than olefin thermoplastic elastomer ((a) constituent) composing the rough surface portion.

In a preferred embodiment of the glass run channel of the invention, the resin main portion makes up the lip portion, the base portion and the side wall portion integrally. And the rough surface portion is provided at least partially on the surface of the resin main portion. This glass run channel is suitable as an upper glass run channel mounted from the side to upper portion of the window frame of the vehicle or a side glass run channel mounted on the side portion of the window frame of the vehicle.

Also, in another preferred embodiment of the glass run channel of the invention, the base portion and the side wall portion are made up of a long metallic main portion (e.g., a rolled sheet metal). The long resin main portion overhangs from the side wall portion of the metallic main portion inside the groove to make up the lip portion. The rough surface portion is provided in a predetermined part on the surface of the resin main portion (lip portion). This glass run channel is suitable as the glass run channel (also called a lower sash) installed within the door panel (lower part of the window frame) of the vehicle.

The rough surface portion is formed with the corrugated face having a number of small projections on the surface, in which the overall shape (outer shape) of the rough surface portion is layered (e.g., a layer having an almost uniform thickness). This layered rough surface portion is molded to provide an almost smooth surface. The average thickness of the layered rough surface portion is preferably in a range from 10 to 100 μm, and more preferably in a range from 25 to 75 μm. For example, the layered rough surface portion having an average thickness from 10 to 100 μm maybe provided over the almost entire surface of the resin main portion making up the lip portion on the glass window pane side to conform to the contour of the resin main portion. The rough surface portion 40 as schematically shown in FIG. 10 is one example of this layered rough surface portion.

Also, the rough surface portion has a shape (outer shape) as a whole in which a plurality of line-like protruded portions extending longitudinally are formed at an interval in the width direction. The surface of the protruded portions is the corrugated face formed with a number of small projections. That is, the line-like protruded portion has a higher order structure than the small projections and the corrugation comprising the small projections. The number of protruded portions, the formation density and the cross-sectional shape are not specifically limited, unless the functions of the glass run channel are greatly impeded. Usually, the height from the adjacent portion of the protruded portion (or foot portion of the protruded portion) to the top portion of the protruded portion is preferably in a range from 100 to 2000 μm, and more preferably in a range from 500 to 1500 μm. The formation density of the protruded portions may be from 5 to 20 lines/cm in the width direction of the rough surface portion, and preferably from 7 to 13 lines/cm. The cross-sectional shape (orthogonal to the longitudinal direction) of each protruded portion may be a polygonal shape such as triangle or square. Also, it may be a circular or elliptical shape with a peripheral part cut away. If the top portion of the protruded portion is formed in non-planar shape (convex face), a contact area with the glass window pane is preferably reduced.

FIG. 11 is a schematic cross-sectional view showing a state where the rough surface portion 40 having the line-like protruded portions is formed in a predetermined part on the surface of the resin main portion 20 making up the lip portion. In FIG. 11, the left and right direction corresponds to the width direction of the lip portion, and the direction orthogonal to the paper face corresponds to the longitudinal direction of the lip portion. The parts having the same functions as in FIG. 10 are designated by the same reference signs, and not described here. As illustrated, this rough surface portion 40 has a plurality of line-like protrusions 41 (only one shown in FIG. 11) extending longitudinally and spaced at an interval in the width direction. The cross-sectional shape of the line-like protrusions 41 is triangular. And the surface of the line-like protrusions 41 is formed in a corrugation state where relatively high portion 40H and relatively low portion 40L are mixed. On its corrugated face, a number of small projections 45 formed of solid particles 44 are scattered.

In an example of FIG. 11, the rough surface portion 40 is provided in a predetermined part on the surface of the resin main portion 20. However, the configuration in which the rough surface portion 40 is formed with the line-like protrusions 41 is also applicable in the case where the lip portion has entirely the rough surface portion 40.

The rough surface portion may be formed to present a linear shape (outer shape) extending longitudinally as a whole (i.e., in its entirety). For example, a plurality of linear rough surface portions may be disposed at least partially on the surface of the main portion and spaced at an interval in the width direction. For example, a plurality of linear rough surface portions may be disposed on the surface of the resin main portion making up the lip portion on the glass window pane side and spaced at an interval in the width direction. The number of linear rough surface portions, the arrangement density and the cross-sectional shape are not specifically limited, unless the functions of the glass run channel are greatly impeded. Usually, the height from the surface of the resin main portion (surface adjacent to the linear rough surface portion) to the top portion of the linear rough surface portion is preferably in a range from 100 to 2000 μm, and more preferably in a range from 500 to 1500 μm. The arrangement density of the linear rough surface portion may be from 5 to 20 lines/cm in the width direction of the main portion, and preferably from 7 to 13 lines/cm. The cross-sectional shape (orthogonal to the longitudinal direction) of each linear rough surface portion may be a polygonal shape such as triangle or square. Also, it may be a circular or elliptical shape, in which the top portion of the linear rough surface portion is preferably formed in non-planar shape (convex face).

In the configuration in which the linear rough surface portions are provided at least partially on the surface of the resin main portion; it is preferable that the foot portion of the linear rough surface portion (end portion on the resin main portion side) and the resin main portion are joined. For example, a chemical joining such as welding (typically thermal welding) or bonding is preferably made. Also, the foot portion of the linear rough surface portion may be buried in the resin main portion. The width of a buried portion is preferably greater than the width of an exposed (protruded) portion from the resin main portion. In this way, due to an anchor effect caused by the buried portion in the resin main portion, a binding force between the resin main portion and the linear rough surface portion is further increased. Thereby, the durability of the rough surface portion and the glass run channel is improved.

The glass run channel according to this invention has the rough surface portion in a part of the lip portion slidable with the glass window pane, and also on the groove inside surface in the base portion. Also, the rough surface portion may be provided on one or both of the groove inside surfaces in the side wall portion and the back face of the lip portion opposed to the groove inside surface.

In the case where a plurality of rough surface portions are provided on a plurality of parts of the glass run channel (e.g., lip portion and base portion), the rough surface portions may be made of the molding material having the almost same composition, or the molding materials having different compositions. From the viewpoint of easiness of manufacture, the rough surface portion provided in one glass run channel is preferably made of the molding material having the same composition.

The glass run channel is easily manufactured by the same molding method as conventionally employed to manufacture the glass run channel for vehicle or various kinds of moldings. Typically, the extrusion molding is performed employing the resin molding material (rough surface portion molding material) for forming the rough surface portion and other molding materials and/or preformed moldings, as needed, whereby the glass run channel of a desired shape (cross-sectional shape) is manufactured.

A manufacturing method for manufacturing the glass run channel in which the rough surface portion is provided at least partially on the surface of the long resin main portion formed using a predetermined resin molding material will be described below.

For example, a two-color extrusion molding (co-extrusion molding) is practiced to produce the glass run channel in which the resin main portion and the rough surface portion are integrated longitudinally. That is, each molding material in heated molted state is supplied and merged into an extrusion die having a first supply gate for supplying the molding material (main portion molding material) to form the resin main portion and a second supply gate for supplying the molding material (rough surface portion molding material) to form the rough surface portion, and extruded through an extrusion opening of predetermined shape. Thereby, the glass run channel in which the resin main portion and the rough surface portion are thermally welded and integrated inside one extrusion die is extrusion molded. This method is suitably applied when both molding materials have almost equal molding temperatures and miscibility.

Alternatively, the glass run channel may be manufactured by the following method. That is, a molding material (main portion molding material) for forming the resin main portion is supplied into the extrusion die and a long molding of predetermined cross-sectional shape is extrusion molded from the molding material. The resin main portion is preformed by this extrusion molding.

This resin main portion is wound around a drum, and continuously supplied from the drum into the extrusion die, while a molding material (rough surface portion molding material) for forming the rough surface portion in heated molten state is supplied into the extrusion die, whereby they are extruded through the extrusion opening of predetermined cross-sectional shape. By this extrusion molding, the rough surface portion extending longitudinally is formed in a predetermined part on the surface of the resin main portion. The rough surface portion formed at this time has its surface of the corrugated face formed with a number of small projections. Also, the surface portion of the resin main portion is thermally melted in the extrusion molding, so that the resin main portion and the rough surface portion are integrated by thermal welding.

The molding extruded through the extrusion opening is cooled in a cooling apparatus, pulled out by a pulling apparatus, and cut out by a cutting apparatus, whereby the glass run channel having a desired length is produced. This manufacturing method is suitably employed when the molding material composing the resin main portion and the rough surface portion molding material have greatly different molding temperatures, or when the resin of the molding material has poor miscibility. When the resin has poor miscibility, adhesive may be coated beforehand on the surface fixed with the rough surface portion of the resin main portion that is supplied into the extrusion die. Thereby, the adhesive property between the resin main portion and the rough surface portion is improved.

In the above manufacturing method, the resin main portion extrusion molded before hand is wound around the drum and supplied However, the resin main portion molded by a first extrusion die may be continuously supplied directly to a second extrusion die in which the first extrusion die for molding the resin main portion and the second extrusion die for molding the rough surface portion are arranged in series. In this case, it is unnecessary to store the resin main portion.

Also, the glass run channel assembly comprising the glass run channel according to the invention is manufactured by the same method as the conventional glass run channel assembly. Typically, a predetermined joint portion is injection molded at the end portions of the long glass run channel produced beforehand by the extrusion molding. That is, the longitudinal end portions of the glass run channel are disposed at a predetermined interval (gap) within the cavity of a mold for molding predetermined joint portion and a predetermined molding material is injected into the cavity. Thereby, the joint portion of desired shape is formed in a state where it is connected at each end portion of the glass run channel. The injection molding method itself that does not characterize this invention is not described in detail.

### EXAMPLES

This invention will be described below in detail by way of example. However, the invention may not be limited to the given examples.

### First Example

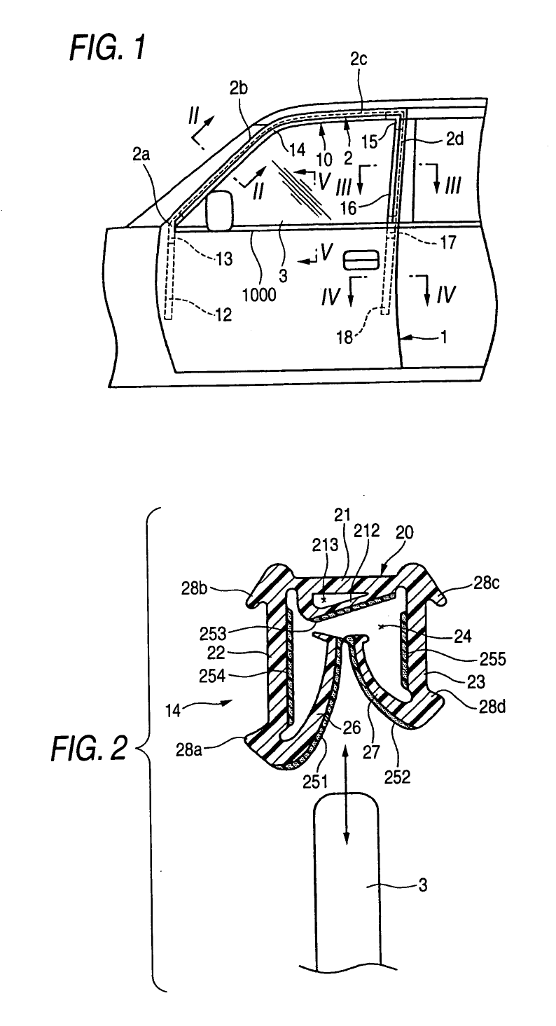

Referring to FIGS. 1 to 6, a first example will be described in connection with a glass run channel assembly 10 mounted on a window frame 2 for a front door panel 1 of the vehicle and the glass run channels 12, 14, 16 and 18 making up the assembly as shown in FIG. 1.

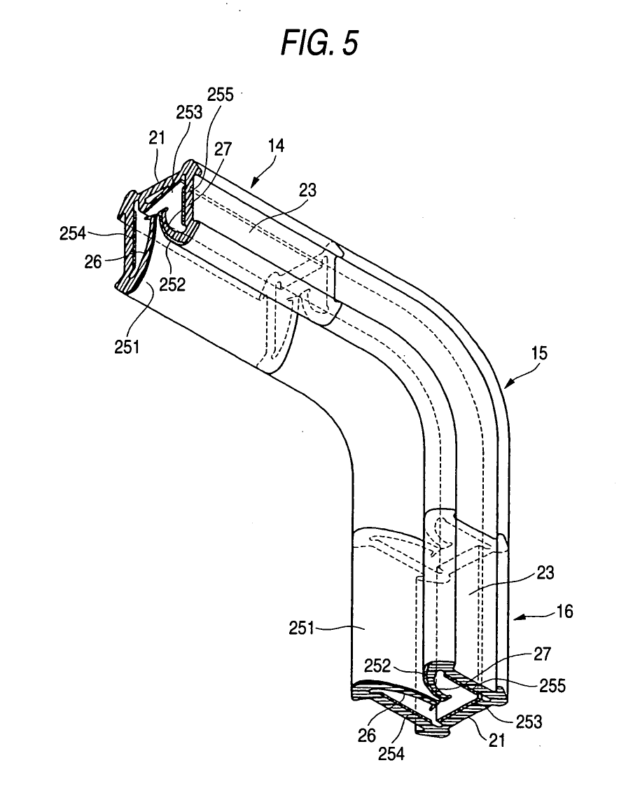

As shown in FIG. 1, the glass run channel assembly 10 in this example comprises four long glass run channels 12, 14, 16 and 18 and three joint portions 13, 15 and 17. That is, a glass run channel 12 is disposed under a front portion 2a of the window frame 2 (inside a door panel 1), a glass run channel 14 is disposed along an inclined portion 2b of the window frame 2 and a portion (roof portion) 2c extending almost horizontally, a glass run channel 16 is disposed along a rear vertical portion 2d of the window frame 2, and a glass run channel 18 is disposed under the rear vertical portion 2d (inside the door panel 1). The glass run channels 12, 14, 16 and 18 are connected by the joint portions 13, 15 and 17, and integrated as the glass run channel assembly 10. This glass run channel assembly 10 is manufactured by injection molding a predetermined joint portion 15 between the end portions of two glass run channels 14 and 16 that are extrusion molded, and connecting both the glass run channels 14 and 16, as shown in FIG. 5.

The structure of each glass run channel will be now described in detail. FIG. 2 is a cross-sectional view taken along the line II-II in FIG. 1 on a plane orthogonal to the longitudinal direction of the upper glass run channel 14 disposed in the inclined portion 2b and the roof portion 2c.

As shown in FIG. 2, the upper glass run channel 14 in this example has, as a principal component, the resin main portion 20, forming a groove 24 extending along the longitudinal direction, when mounted on the window frame 2 (2c). wherein, the groove 24 has an opening into which a peripheral edge of the glass window pane 3 enters when the glass window pane 3, movable up or down, ascends. The resin main portion 20 comprises a base portion 21 corresponding to the base of the groove 24, a pair of side wall portions 22 and 23 (i.e., an interior side wall portion 22 and an exterior side wall portion 23) rising from both ends of the base portion 21 in the width direction and becoming the side walls of the groove 24, and a pair of lip portions 26 and 27 overhanging from the free end portions of the side wall portions 22 and 23 to the inside of the groove and resiliently pressed onto the surface of the glass window pane 3 carried in the groove 24. A cushion portion 212 is provided by a hollow space 213 extending longitudinally on the side of the base portion 21 facing the groove 24. This cushion portion 212 cushions the glass window pane when the ascending glass window pane 3 enters the groove 24 to strike against the base portion 21. Thereby, an impact sound is suppressed. On the outside of the side wall portions 22 and 23, the fixing lip portions 28b and 28c hung on the inside of the window frame to carry the glass run channel 14 in a glass run channel mounting groove (not shown) provided on the side of the window frame, and the cover lip portions 28a and 28d for covering the edges of the window frame, not shown.

This resin main portion 20 is a long main portion that is extrusion molded employing a molding material (main portion molding material) containing olefin thermoplastic elastomer (hereinafter often denoted “TPO(1)”) that is a blend of 25 parts of polypropylene resin, 40 parts of EPDM and 30 parts of process oil (paraffin or naphthene base), and 5 parts of other auxiliary constituents. The hardness of TPO(1) composing the resin main portion 20 is about 75 degrees in a durometer hardness A according to JIS K 7215.

As shown in FIG. 2, the rough surface portions 251 and 252 are integrally formed longitudinally on the surface of the interior lip portion 26 and the exterior lip portion 27 on the outer side (pressed onto the glass window pane 3). The overall shape of the rough surface portions 251 and 252 is layered (like a thin film), its average thickness being about 50 μm. The surface of the rough surface portions 251 and 252 is in a corrugation state, as seen microscopically, in which relatively high portion and relatively low portion are mixed, like the rough surface portion 40 as schematically shown in FIG. 10. A number of small projections with solid particles are formed on the corrugated face in such corrugation state.

The rough surface portions 251 and 252 are formed employing a rough surface portion molding material containing olefin thermoplastic elastomer (hereinafter often denoted “TPO(2)”) that is a blend of 70 parts of polypropylene resin, 15 parts of EPDM and 15 parts of process oil (paraffin or naphthene base). That is, TPO(2) is olefin thermoplastic elastomer containing polypropylene as hard segment at a ratio of 50 mass % or more (i.e., 70 mass %) of the total. The hardness of TPO(2) is higher than the hardness of the resin main portion 20, and about 58 degrees in a durometer hardness D according to JIS K 7215. And the rough surface portion molding material contains, at a mass ratio, 100 parts of TPO(2), 5 parts of spherical silicon resin as solid particles (spherical silicon resin particles made by GE Toshiba Silicon, trade name “Tospearl (trademark)”, average particle diameter of about 12 μm), 8 parts of silicon oil as liquid lubricant (dimethyl silicon oil made by Toray Dow Corning Silicon, trade name “SH200”), 5 parts of acrylic silicon resin (silicon acryl copolymer resin powder made by Shinetsu Chemical, trade name “X-22-8171”), and 2 parts of erucic acid amide (made by Nippon Oil & Fats).

Also, the upper glass run channel 14 is provided with a rough surface portion 253 on the groove inside surface (on the side facing the groove 24) in the base portion 21 (cushion portion 212), in addition to the outer face of the lip portions 26 and 27. Furthermore, the rough surface portions 254 and 255 are provided on the groove inside surfaces of the side wall portions 22 and 23. These rough surface portions 253 to 255 are molded of the same rough surface portion molding material as the rough surface portions 251 and 252 provided on the lip portions. These rough surface portions 251, 252, 253, 254 and 255 are integrally formed longitudinally on predetermined parts on the surfaces of the lip portions 26, 27, the base portion 21, and the side wall portions 22, 23, in which the average thickness of the rough surface portions 251 and 252 in the lip portions is in a range from 1 to 100 μm (here 50 μm), the average thickness of the rough surface portion 253 in the base portion is in a range from 300 to 1000 μm, and the average thickness of the rough surface portions 254 and 255 in the sidewall portions is in a range from 100 to 300 μm. The rough surface portions 251 to 255 provided on the glass run channel 14 in this example have miscibility with the corresponding parts (lip portions, base portion and side wall portions) of the resin main portion, and welded at the time of co-extrusion.

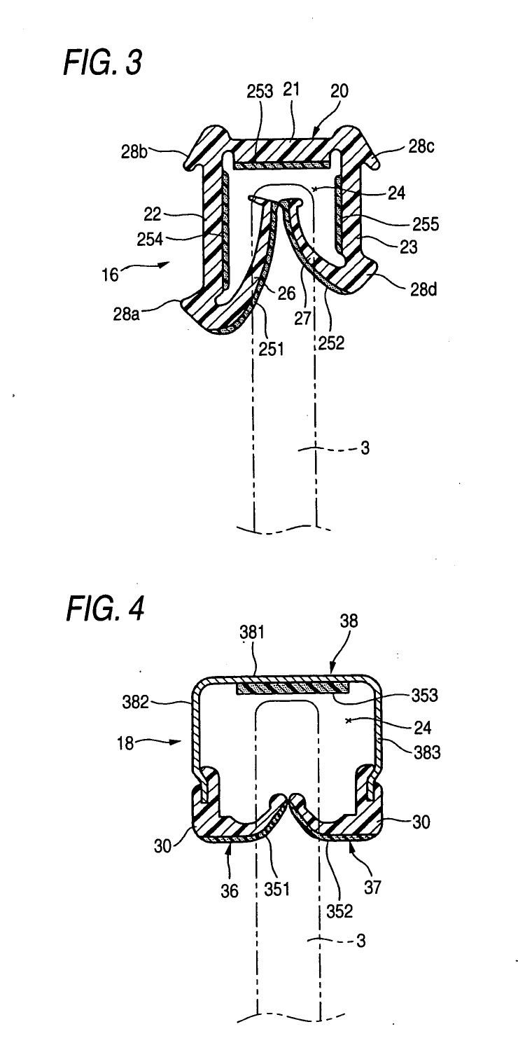

The structure of a side glass run channel 16 disposed along the rear vertical portion 2d will be now described in detail. FIG. 3 is a cross-sectional view taken along the line III-III in FIG. 1 on a plane orthogonal to the longitudinal direction of the side glass run channel 16 disposed in the rear vertical portion 2d. The parts having the same functions as the upper glass run channel 14 are designated by the same reference signs, and not described here.

As shown in FIG. 3, the side glass run channel 16 has, as a principal component, the resin main portion 20, forming the groove 24 extending along the longitudinal direction, when mounted on the window frame 2 (2d) . This groove 24 has an opening into which a rear peripheral edge of the glass window pane 3, movable up or down, enters. The glass window pane 3 ascends or descends in the longitudinal direction (direction orthogonal to the paper face of FIG. 3) along the side glass run channel 16. The resin main portion 20 is made of the same main portion molding material as the upper glass run channel 14, and comprises the base portion 21, a pair of side wall portions 22 and 23, and a pair of lip portions 26 and 27 overhanging from the side wall portions 22 and 23. In this side glass run channel 16, the edge of the glass window pane 3 and the base portion 21 of the glass run channel are designed to have a gap of about 1.3 to 3.5 mm. However, when the glass window pane ascends or descends, the edge of the glass window pane may slide with the base portion 21, owing to an error in the outer size of the glass window pane or a construction error of the window frame. Unlike the upper glass run channel 14, the edge of the glass window pane 3 does not strike against the base portion 21. Accordingly, the base portion 21 of the resin main portion 20 in the side glass run channel 16 is not formed with the cushion portion (as indicated by sign 212 in FIG. 2), unlike the upper glass run channel 14. That is, this base portion 21 is formed roughly flat, as shown in FIG. 3.

This side glass run channel 16, like the upper glass run channel 14 (see FIG. 2), is provided with the rough surface portions 251 to 255 made of the same rough surface portion molding material as the upper glass run channel 14 on the outer side of the lip portions 26 and 27, the groove inside surface of the base portion 21 and the groove inside surfaces of the side wall portions 22 and 23. These rough surface portions 251 to 255 are molded in the same outer shape and contour as the rough surface portions 251 to 255 making up the upper glass run channel 14, and similarly welded in predetermined parts of the resin main portion 20.

The upper glass run channel 15 and the side glass run channel 16 as described above is easily manufactured by co-extrusion, employing an apparatus including a first extrusion machine 80 and a second extrusion machine 83 connected to an extrusion die 82 having a first supply gate 81a for the resin main portion molding material and a second supply gate for the rough surface portion molding material, as shown in FIG. 13. That is, the main portion molding material and the rough surface portion molding material are supplied in heated molten state and merged into the extrusion die 82, and extruded through an extrusion opening of cross-sectional shape as shown in FIG. 2 or 3, producing a glass run channel member 84. This manufacturing method is suitably applied when both the molding materials have equal or almost equal molding temperatures and miscibility.

An alternative manufacturing method will be described below. First of all, the main portion molding material is supplied into the first extrusion die, and the resin main portion is extrusion molded, employing the first extrusion die. Then, the resin main portion is continuously supplied to the second extrusion die, and the rough surface portion molding material in heated molten state is supplied to the extrusion die and extruded through the extrusion opening of cross-sectional shape as shown in FIG. 2 or 3. Thereby, the molding material composing the preformed resin main portion and the rough surface portion molding material supplied in heated molten state are welded and joined longitudinally, thereby producing the glass run channels 14 and 16 having the resin main portion 20 and the rough surface portions 251 to 255 integrated. This latter method is suitably applied when both the molding materials have miscibility but different molding temperatures.

In FIG. 2 or 3, the glass run channel 14 or 16 is shown in the cross-sectional shape when mounted on the window frame 2, and the window frame 2 is not shown.

The structure of the glass run channel (lower sash) 12, 18 contained inside the door panel 1 will be now described. FIG. 4 is a cross-sectional view taken along the line IV-IV in FIG. 1 on a plane orthogonal to the longitudinal direction of the lower sash 18 disposed under the rear vertical portion 2d. The glass run channel 12 disposed under the front end portion of the window frame has also the same structure. The parts having the same functions as the upper glass run channel 14 are designated by the same reference signs, and not described here

As shown in FIG. 4, the glass run channel 18 has a metallic main portion 38 including a sheet metal (sheet metal strip member) that is roll formed. This main portion 38 is formed with the groove 24 extending longitudinally, and comprises a base portion 381 corresponding to the bottom of the groove 24, and a pair of side wall portions 382 and 383 rising from both ends of the base portion 381 in the width direction and becoming the side walls of the groove 24. The glass window pane 3 ascends or descends in the longitudinal direction (orthogonal to the paper face in FIG. 4) along the glass run channel 18. The side wall portions 382 and 383 comprise, at the free end portions, a pair of lip portions 36 and 37 overhanging from the side wall portions 382 and 383 and resiliently pressed onto the surface of the glass window pane 3 carried in the groove 24. The lip portions 36 and 37 comprise the long resin main portions 30, and the rough surface portions 351 and 352 provided in predetermined parts on the surface of the lip portions pressed onto the surface of the glass window pane 3. The resin main portion 30 is made of the same main portion molding material as the resin main portion 20 making up the upper glass run channel 14, and the rough surface portions 351 and 352 are made of the same rough surface portion molding material as the upper glass run channel 14 (see FIG. 2). The rough surface portions 351 and 352 are molded in the same outer shape and contour as the rough surface portions 251 to 255 making tip the upper glass run channel 14, and welded with the lip portions 36 and 37. Also, a rough surface portion 353 is integrally formed on the groove inside surface of the base portion 381, like the base portion 21 of the side glass run channel 16.

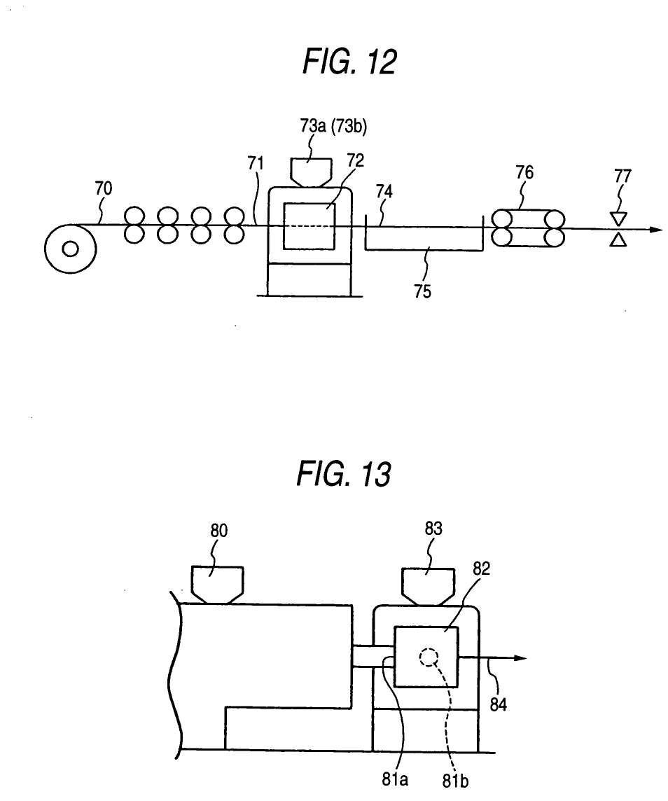

The glass run channel 18 is easily manufactured, employing an apparatus as illustrated in FIG. 12. That is, first of all, a sheet metal 70 is passed between a plurality of molding rolls to form a metallic main portion 71 by roll forming, and the metallic main portion 71 is continuously supplied to an extrusion die 72, while the main portion molding material and the rough surface portion molding material are supplied in heated molten state to the extrusion die 72 by two extrusion machines 73a and 73b and extruded through an extrusion opening to form a glass run channel member (intermediate molding) 74. Thereby, the intermediate molding 74 including the metallic main portion 38 and the resin main portion 30 connected is produced, as shown in FIG. 4. Then, the intermediate molding 74 is fed to a cooling apparatus 75, and the cooled intermediate molding 74 is pulled out by a pulling apparatus 76, and cut out in a predetermined length by a cutting apparatus 77. Thereby, the molding material of the resin main portion 30 provided for the intermediate molding 74 and the rough surface portion molding material supplied in heated molted state are welded and joined longitudinally, thereby producing the glass run channel 18 of this example having the resin main portion 30 and the rough surface portions 351, 352 and 353 integrated.

With the glass run channels 12, 14, 16 and 18 of the above configuration, the rough surface portions 251, 252 and 351, 352 having a predetermined composition and contour are provided on the surface of the lip portions 26, 27, 36 and 37 pressed onto the glass window pane face, whereby the sliding resistance of the lip portions 26, 27, 36 and 37 with the-glass window pane 3 is reduced, and the low sliding resistance is maintained over the long time (against a number of slidings). Employing the rough surface portion molding material having the above composition, the rough surface portions 251, 252 and 351, 352 having the contour are easily produced (at the same time with the extrusion molding). The rough surface portions 251, 252 and 351, 352 are formed in predetermined parts on the surface of the resin main portions 20 and 30 made of the molding material having more excellent flexibility than the rough surface portions. Accordingly, the lip portions 26, 27, 36 and 37 are pressed onto the face of the glass window pane 3 by an adequate resilient force. Olefin thermoplastic elastomer (TPO(1)) composing the rough surface portion 251 and olefin thermoplastic elastomer (TPO(2)) composing the resin main portion 20 have commonly hard segment (polypropylene) and soft segment (EPDM), and have miscibility and excellent welding ability. Accordingly, the resin main portions 20 and the rough surface portions 251 are welded appropriately due to a heat during the extrusion molding. Since both the resin main portions 20 and the rough surface portions 251 are welded at the boundaries, the glass run channels 12 in this example have the excellent durability of the rough surface portions 251. For example, the rough surface portions 251 are effectively prevented from being peeling away from the resin main portions 20.

In the upper glass run channel 14, the side glass run channel 16 and the lower sash 18, the rough surface portions 253, 353 are provided on the surface confronting the groove 24 of the base portions 21, 381, in addition to the lip portions, whereby the effect of reducing the sliding resistance with the glass window pane 3 and the effect of maintaining the lower sliding resistance are further enhanced. The sliding resistance of the lip portions 26 with the glass window pane 3 and the sliding resistance of the base portion 21 with the glass window pane 3 (especially its end face) are maintained low over the long time, whereby the misregistration of the glass run channels 14 and 16 caused by the sliding resistance is suppressed. That is, in the side glass run channel 16, the rough surface portion is formed on the lip portions 26, 27 in contact with the surface of the glass window pane 3, and the base portion 21 that may contact with the end face of the glass window pane 3, whereby the sliding resistance when the glass window pane 3 ascends or descends is maintained low over the long time, and the side glass run channel 16 is prevented from being misregistered upward or downward within the window frame. On the other hand, in a portion of the upper glass run channel 14 disposed in the inclined portion 2b of the window frame 2, the glass window pane 3 ascends to firstly contact with the lip portions 26, 27, then with the base portion 21, and stops to ascend, so that the end face of the glass window pane 3 makes contact with the base portion 21 to force the base portion 21 to push obliquely upwards immediately before stopping to ascend. However, since the rough surface portion 253 is provided in the base portion 21, the end face of the glass window pane 3 slips along the longitudinal direction of the base portion 21. Thereby, the glass run channel 14 is prevented from being misregistered in the window frame 2. Moreover, in these glass run channels 14 and 16, the rough surface portions 254 and 255 are provided on the surface confronting the groove 24 of the side wall portions 22 and 23. Owing to these rough surface portions 254 and 255, the back faces of the lip portions 26 and 27 are prevented from sticking to the side wall faces 22 and 23, and the noise is prevented from occurring when the lip portions 26 and 27 are separated from the side wall portions 22 and 23. In the glass run channel assembly 10 including these glass run channels 12, 14, 16 and 18, the operation of each glass run channel is effectively exhibited.

As described above, since olefin thermoplastic elastomer (TPO(2)) composing the rough surface portions has a higher hardness than olefin thermoplastic elastomer (TPO(1)) composing the resin main portion, the rough surface portion is also employed as a core material for adjusting at least one of the characteristics including the shape maintenance, resiliency, and linear expansion coefficient for the base portion and/or side wall portions in the glass run channel. For this purpose, the thickness of the rough surface portion in the base portion and/or side wall portions is suitably in a range from 100 to 1000 μm (preferably from 300 to 1000 μm for the base portion, and from 100 to 300 μm for the sidewall portion) Generally, it is not required that these portions have as high a resiliency (flexibility) as the lip portions. It is particularly preferable that the rough surface portion having a core feature is provided in the base portion. Generally, the end face of the glass window pane is not so smooth as the polished surface, or roughened as microscopically seen. Therefore, the base portion making contact with the end face of the glass window pane is more likely to wear than the other portions, whereby it is effective for maintaining the sliding resistance low over the long time to increase the thickness of the rough surface portion in this base portion.

A surface layer (which may or may not correspond to the rough surface portion) was formed on the surface of the resin main portion made of the main portion molding material having the same composition as the resin main portion 20 composing the glass run channel 14, employing the molding materials (1) to (10) as listed below, to produce the corresponding moldings 1 to 10, whereby the sliding resistance values of the glass window pane with those moldings were evaluated.

[Molding Material (1)]

The molding material had the same composition as the rough surface portion molding material as employed to form the rough surface portions 251 to 255 provided for the glass run channel 14. That is, the molding material contained, at a mass ratio, 100 parts of TPO(2), 5 parts of the spherical silicon resin particles as solid particles (made by GE Toshiba Silicon, trade name “Tospearl (trademark)”, average particle diameter of about 12 μm), 8 parts of the silicon oil as liquid lubricant, 5 parts of the acrylic silicon resin and 2 parts of erucic acid amide.

[Molding Material (2)]

Instead of the spherical silicon resin particles, 5 parts of spherical silicon resin particles (made by GE Toshiba Silicon, trade name “Tospearl (trademark)”, average particle diameter of about 6 μm) were employed. Other compositions were the same as the molding material (1).

[Molding Material (3)]

Instead of the spherical silicon resin particles, 5 parts of spherical silicon resin particles (made by GE Toshiba Silicon, trade name “Tospearl (trademark)”, average particle diameter of about 3 μm) were employed Other compositions were the same as the molding material (1).

[Molding Material (4)]

The molding material contained, at a mass ratio, 100 parts of TPO(2), 5 parts of the spherical silica particles as solid particles (made by Electric Chemical Industries, trade name “Denka Fused Silica FB-35”, average particle diameter of about 11 μm), 2.5 parts of the silicon oil, 2 parts of erucic acid amide, 40 parts of high molecular weight polyethylene, and 10 parts of high molecular weight polyethylene powder.

[Molding Material (5)]

Instead of the spherical silica particles, 5 parts of spherical silica particles (made by Electrical Chemical Industries, trade name “Denka Fused Silica”, average particle diameter of about 8 μm) were employed. Other compositions were the same as the molding material (4).

[Molding Material (6)]

The molding material contained, at amass ratio, 100 parts of TPO(2), 5 parts of the spherical silicon resin particles as solid particles (average particle diameter about 12 μm), 5 parts of the acrylic silicon resin, and 2 parts of erucic acid amide. This molding material (6) contained substantially no component corresponding to the liquid lubricant (e.g., silicon oil).

[Molding Material (7)]

The molding material contained, at amass ratio, 100 parts of TPO(2), 2.5 parts of the silicon oil, 2 parts of erucic acid amide, 40 parts of high molecular weight polyethylene, and 10 parts of high molecular weight polyethylene powder. This molding material (7) contained substantially no component corresponding to the solid particles (e.g., spherical silicon resin particles, spherical silica particles).

[Molding Material (8)]

The molding material contained, at a mass ratio, 100 parts of TPO(2), 4.5 parts of silicon oil, 3 parts of erucic acid amide, 40 parts of high molecular weight polyethylene, 5 parts of the spherical silicon resin particles as solid particles (made by GE Toshiba Silicon, trade name “Tospearl (trademark)”, average particle diameter of about 6 μm), and 10 parts of spherical polymethyl methacrylate resin particles (made by Ganz Chemical, trade name “Ganz Pearl GM2801”, average particle diameter of about 28 μm).

[Molding Material (9)]

Of the solid particles, instead of the spherical polymethyl methacrylate (PMMA) resin particles, 10 parts of spherical PMMA resin particles (made by Ganz Chemical, trade name “Ganz Pearl GM5003”, average particle diameter of about 50 μm) having different average particle diameter. Other compositions were the same as the molding material (8).

[Molding Material (10)]

Of the solid particles, instead of the spherical PMMA resin particles, 10 parts of spherical PMMA resin particles (made by Ganz Chemical, trade name “Ganz Pearl GM9005”, average particle diameter of about 85 μm) having different average particle diameter. Other compositions were the same as the molding material (8).

The moldings 1 to 10 were produced in the following way. That is, first of all, the main portion molding material (containing 100 parts of TPO(1) and 5 parts of auxiliary constituents at a mass ratio) and the molding materials (1) to (10) were supplied in heated molten state to the extrusion die for co-extrusion and extruded through the extrusion opening. Thereby, the moldings 1 to 10 were produced in which the surface layers composed of the molding materials (1) to (10) and having a thickness of about 50 μm were formed on one surface of the resin molding having a thickness of about 1.5 mm. Observing the appearance of the surface layers provided for these moldings with the eyes, a surface layer of molding 6 had relatively excellent glossiness, and low surface roughness. On the contrary, the surface layers of the moldings 1 to 5 and 8 to 10 were in grayed state. Minutely observing the surface layers, it was found that the corrugated faces 40H, 40L, 40H, 40L, . . . formed like orange peel having a number of small projections 45 were formed with large surface roughness, as schematically shown in FIG. 10. In the moldings 1 to 5 and 8 to 10, the corrugated face of orange peel is formed, because the flow rate of molten material (molding material) for formation of the rough surface portion that flows in compressed condition through the extrusion die during extrusion molding may be partially changed. That is, when there is no silicon oil layer in the contact portion with the flow passage face of the die, a part of the material directly contacts with the flow passage face of the die, as microscopically seen, and flows relatively slowly, or when there is a silicon oil layer, the silicon oil as liquid lubricant acts as a plain layer so that the material flows relatively fast. Moreover, owing to interaction of the molding materials (1) to (5) and (8) to (10) with solid particles, the corrugated face having a number of small projections were excellently formed on the moldings 1 to 5 and 8 to 10, as shown in FIG. 10.

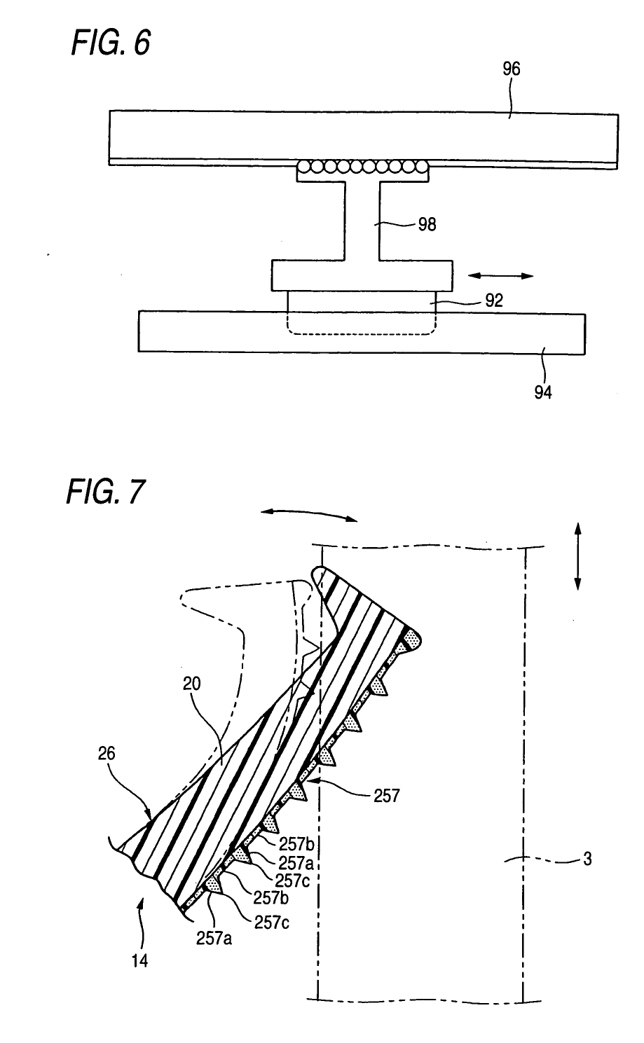

The sliding resistance of the moldings 1 to 10 with the glass face was measured. That is, a tempered glass plate (with the surface finish corresponding to the side glass window pane for automobile) having a width of 100 mm, a height of 50 mm and a thickness of 3.5 mm was prepared. On the other hand, test pieces were fabricated by cutting the moldings 1 to 7 into a length of 300 mm. As shown in FIG. 6, the tempered glass plate 92 was held on a sliding resistance measurement machine 98 that can be reciprocated along a rail 96, and reciprocated repetitively in a range of 150 mm in length in the longitudinal direction of the test piece 94, while the surface of the tempered glass plate 92 in a range of 20 mm from the lower end was pressed against the surface of the test piece 94 (on the side where the surface layer was formed) at a load of 9.8N. The sliding speed of the glass plate 92 with the test piece 94 was 200 mm/s. For each of the moldings 1 to 10, the sliding resistance (initial sliding resistance) when the number of reciprocating the glass plate 92 reached 1000, and the sliding resistance (latter sliding resistance) when it reached 2000 were measured. The results are shown in Table 1. In this Table 1, the rough composition and surface condition of the surface layer provided for each molding are also shown.

TABLE 1

| | | | | Sliding | |
|---|---|---|---|---|---|
| | Composition (part)*1 | | | resistance | |
| | Solid | Liquid | Surface | (N/100 mm) | |
| | Particles | lubricant | condition*2 | Initial | Latter |
| Molding | 5 | 8 | good | 6.5 | 8.2 |
| 1 | | | | | |
| Molding | 5 | 8 | good | 8.1 | 7.4 |
| 2 | | | | | |
| Molding | 5 | 8 | good | 7.5 | 9.1 |
| 3 | | | | | |
| Molding | 5 | 2.5 | good | 7.1 | 9.1 |
| 4 | | | | | |
| Molding | 5 | 2.5 | good | 9.7 | 8.9 |
| 5 | | | | | |
| Molding | 5 | None | bad | 8.5 | 12.5 |
| 6 | | | | | |
| Molding | None | 2.5 | bad | 7.0 | 12.3 |
| 7 | | | | | |
| Molding | 5 + 10 | 4.5 | good | 3.6 | 3.9 |
| 8 | | | | | |
| Molding | 5 + 10 | 4.5 | good | 5.5 | 4.1 |
| 9 | | | | | |
| Molding | 5 + 10 | 4.5 | good | 4.1 | 3.5 |
| 10 | | | | | |

*1: Content ratio to 100 parts of TPO(2) (mass ratio)
*2: ″good″ if the corrugated face formed with a number of small projections is formed, or otherwise ″bad″.

As can be seen from Table 1, in the moldings 1 to 5 in which the rough surface portion having the composition and contour of the invention was formed as the surface layer, the initial sliding resistance was reduced to a low value (e.g., 10N/10 mm or less), and the sliding resistance value (e.g., 10N/100 mm or less) was maintained low up to the latter term. Specifically, in the moldings 1 to 5, the initial sliding resistance value (sliding number: 1000) and the latter sliding resistance value (sliding number: 20000) had an increase rate of 30% or less. Herein, the increase rate (%) of the sliding resistance value is calculated by the following formula.
{(Latter sliding resistance value−initial sliding resistance value)/initial sliding resistance value}×100

Also, in the moldings 8 to 10 in which the rough surface portion having the composition and contour of the invention was formed as the surface layer, the initial sliding resistance was reduced to a low value (e.g., 10N/10 mm or less, particularly 6N/100 mm or less), and the sliding resistance value (e.g., 10N/100 mm or less, particularly 6N/100 mm or less) was maintained low up to the latter term. Specifically, in the moldings 8 to 10, the sliding resistance value had an increase rate of 5% or less.

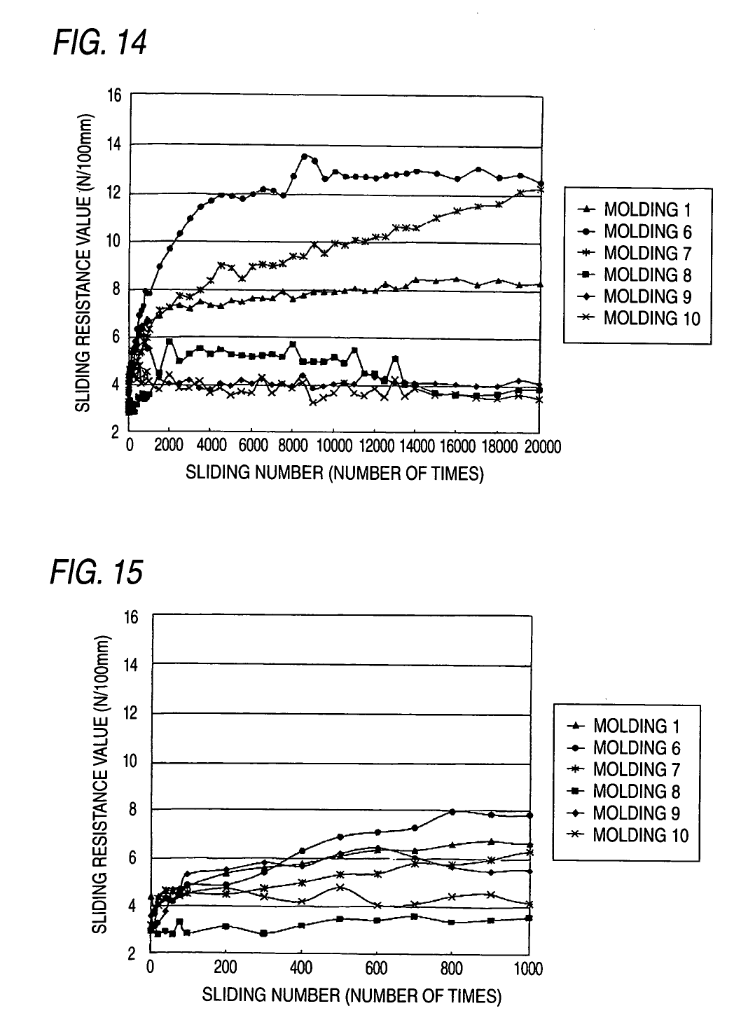

FIG. 14 is a graph representing the results of the above sliding test for the moldings 1, 6 and 7. The transverse axis of the graph represents the sliding number (number of reciprocating movements) and the longitudinal axis represents the sliding resistance value. As will be seen from this graph, in the molding 1 having the rough surface portion of the invention, the sliding resistance value is maintained low (10N/100 mm or less) from the initial to latter term. On the other hand, in the molding 6 that does not contain the solid particles and is not formed with the rough surface portion of the invention, the sliding resistance is clearly kept higher from the initial to latter term than in the molding 1. Also, in the molding 7 that does not contain the solid particles and is not formed with the rough surface portion of the invention, the initial sliding resistance value is equivalent to that of the molding 1, but if the sliding number is greater, the sliding resistance is greatly increased as compared with the molding 1. For example, if the sliding number is about 10000 times or more, the sliding resistance value exceeds 10N/100 mm.

Also, in the moldings 8 to 10 in which solid particles having relatively large average particle diameter were added (two kinds of solid particles having different average particle diameter and material are employed together), more excellent results than the molding 1 were obtained. That is, the initial sliding resistance value was reduced to a low value. Also, an increased sliding resistance value in the latter term was suppressed more excellently. In these moldings, the surface roughness was increased (greater) and the contact area with the glass was reduced to effectively suppress an increase in the sliding resistance by further adding solid particles having larger particle diameter.

FIG. 15 is a graph enlarging an initial (sliding number of 1000 or less) part of FIG. 14. In the moldings 8 and 10, the sliding resistance value in this range was maintained lower. The sliding resistance value of the molding 9 reaches a peak once from the sliding number up to 1000 (about 600), in which the sliding resistance value at the peak is suppressed to 10N/100 mm or less. Also, the sliding resistance value after the peak is kept at low value.

### Second Example

This second example is different from the first example in the overall shape (outer shape) of the rough surface portion provided for the lip portion. In the following, the different points from the first example will be mainly described.

FIG. 7 is an enlarged view of the lip portion 26 in each of the upper and side glass run channels 14 and 16 in this example, or a schematic cross-sectional view showing a cross section orthogonal to the longitudinal direction. A rough surface portion 257 made of the same rough surface portion molding material as in the first example is formed in a part on the surface of the lip portion pressed onto the surface of the glass window pane 3. This rough surface portion 257 is provided in a predetermined part of the lip portion 26 on the surface of the resin molding 20. The rough surface portion 257 is formed with a plurality of line-like protruded portions 257a extending longitudinally and spaced at an interval in the width direction. The cross-sectional shape of each protruded portion 257a is almost triangular. The adjacent protruded portions 257a are connected by a base portion 257b. The width of each base portion 257b may be about 0.5 to 5 mm, for example. Also, the thickness of each base portion 257b may be about 5 to 50 μm, for example. The average height from the surface of the base portion 257b to a top portion 257c of the protruded portion 257 may be about 100 to 2000 μm, for example. The formation density of the protruded portions 257a may be about 5 to 20 lines/cm in the width direction of the rough surface portion 257. And the surface of each protruded portion 257a is a corrugated face (40H, 40L, 40H, 40L, . . . ) in which a number of relatively high portions 40H and a number of relatively low portions 40L are mixed, and a number of small projections 45 are further formed on the corrugated face, as schematically shown in FIG. 11. The rough surface portion 257 and the resin main portion 20 are thermally welded at its boundary.

In FIG. 7, how the overall shape of the lip portion 26 having the rough surface portion 257 is deformed in the width direction by the glass window pane 3 is indicated by the two-dot chain line. As illustrated, since the rough surface portion 257 has the line-like protruded portions 257a of triangular shape in cross section, the surface of the glass window pane 3 and the rough surface portion 257 (lip portion 26) are linearly contacted (line contact) mainly at the top portions 257c of the protruded portions 257a. Accordingly, the contact area between the rough surface portion 257 and the surface of the glass window pane 3 is smaller in this example than when this rough surface portion has a layer in the overall shape. Therefore, the sliding resistance is further reduced. Also, this rough surface portion 257 has the protruded portions 257a (thicker portions) extending longitudinally and the base portions 257b (thinner portions) provided alternately in the width direction. The rough surface portion 257 having such a configuration is easily resiliently deformed in the width direction (e.g., resiliently deformed in the shape as indicated by the two-dot chain line in FIG. 7) mainly by deformation of the thinner portions of the base portions 257b. That is, when the glass window pane 3 is moved and the lip portion 26 is resiliently deformed into the shape as indicate by the two-dot chain line, the thinner base portions 257b are substantially deformed. Accordingly, in the lip portion 26 comprising the rough surface portion 257 formed of olefin thermoplastic elastomer having a higher hardness than olefin thermoplastic elastomer of the resin main portion 20, the rough surface portion 257 is appropriately resiliently deformed (mainly in the width direction) along with the resin main portion 20, thereby fully exhibiting the feature of the lip portion 26.

### Third Example

This third example is different from the first and second examples in the overall shape (outer shape) of the rough surface portion provided for the lip portion. In the following, the different points from the first and second examples will be mainly described.

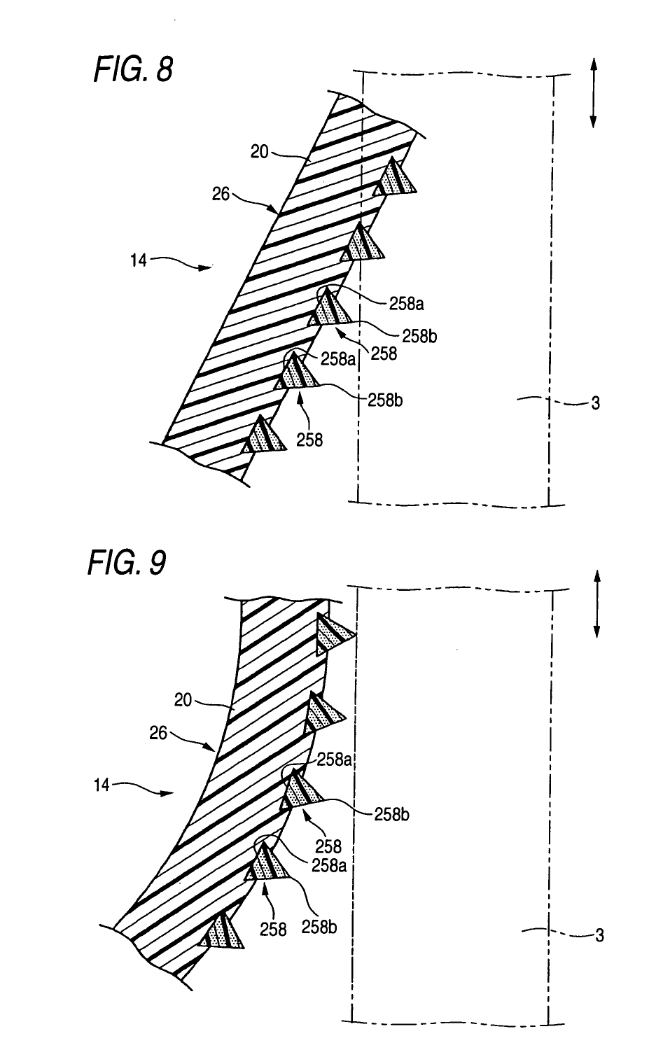

FIG. 8 is an enlarged view of the lip portion 26 in each of the upper and side glass run channels 14 and 16 in this example, or a schematic cross-sectional view showing its cross section. The lip portion 26 has a plurality of rough surface portions 258 made of the same rough surface portion molding material as in the first example that are formed in a part pressed onto the surface of the glass window pane 3. These rough surface portions 258 are formed in linear outer shape as a whole. The plurality of rough surface portions 258 are provided in a predetermined part on the surface of the resin main portion 20 making up the lip portion 26 and spaced at an interval in the width direction. The resin main portion 20 and each rough surface portion 258 are thermally welded at its boundary. The cross-sectional shape of each rough surface portion 258 orthogonal to the longitudinal direction is almost triangular. A foot portion (bottom portion) 258a is buried in the resin main portion 29 to cause an anchor effect. The interval between adjacent rough surface portions 258 may be about 0.5 to 5 mm on the bottom face of the rough surface portion 258, for example. Also, the average height from the surface of the resin main portion 20 to a top portion 258b of the rough surface portion 258 may be about 100 to 2000 μm, for example. The formation density of the rough surface portions 258 may be about 5 to 20 lines/cm in the width direction of the resin main portion 20. And the surface of the rough surface portion 258 is a corrugated face formed with a number of small projections.

FIG. 9 shows how this overall shape of the lip portion 26 having the rough surface portions 258 is deformed in the width direction by the glass window pane 3. As illustrated, since the lip portion 26 is provided with the linear rough surface portions 258 of triangular shape in cross section, the surface of the glass window pane 3 and the lip portion 26 are typically linearly contacted (line contact) mainly at the top portions 258b of the rough surface portions 258. Accordingly, the contact area between the rough surface portions 258 and the surface of the glass window pane 3 is smaller in this example than when this rough surface portion has a layer in the overall shape. Thereby, the sliding resistance is further reduced. Also, this resin main portion 258 has a part provided with the rough surface portion 258 extending longitudinally and a part not provided with the rough surface portion 258, which are provided alternately in the width direction. The lip portion 26 having such a configuration is easily resiliently deformed in the width direction mainly by deformation of the resin main portion 20 in the parts not provided with the rough surface portion 258. Accordingly, in the lip portion 26 comprising the rough surface portion 258 formed of olefin thermoplastic elastomer having a higher hardness than olefin thermoplastic elastomer of the resin main portion 20, the lip portion 26 is appropriately resiliently deformed, thereby fully exhibiting the feature of the lip portion.

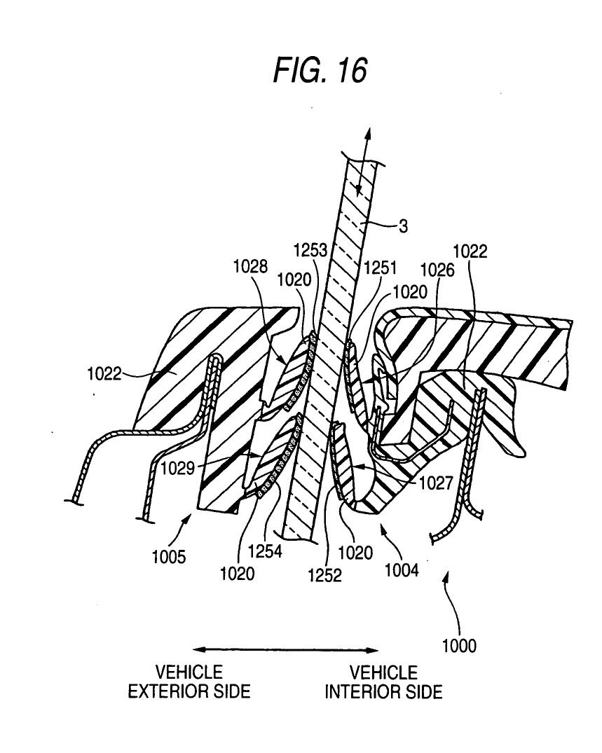

While the glass run channel for vehicle according to the invention and the assembly having the glass run channel have been described above in connection with a few examples, this invention is not limited to those examples in the shape and usage. For example, this invention is also applicable to other vehicle components having a pressure contact portion (lip portion, etc.) resiliently pressed onto the smooth face (glass window pane, vehicle body panel, etc.) of the vehicle. Examples of those vehicle components (typically the long resin molding material) may include so-called weather strips, belt moldings such as an inner (vehicle inside) belt molding mounted at the peripheral edge of a glass inlet or outlet opening in contact with a movable glass and an outer (vehicle outside) belt molding, a front window molding having a pressure contact portion resiliently pressed onto the vehicle panel, and a sun roof molding. FIG. 16 shows an example of a belt molding 1000. The belt molding 1000 includes an inner belt molding 1004 and an outer belt molding 1005. Each of the inner belt molding 1004 and the outer belt molding 1005 has an attach portion 1022 that is attachable along a window frame and lip portions 1026, 1027, 1028 or 1029 for sealing a glass window pane 3. The lip portions 1026, 1027, 1028 and 1029 respectively include a resin main body portion 1020 and a rough surface portion 1251, 1252, 1253 and 1254. The belt molding 1000 is mounted in a vehicle as shown in FIG. 10.

That is, the following techniques are disclosed in this specification.

(1) A long resin molding member mounted on a predetermined mount portion for the vehicle, comprising a pressure contact portion resiliently pressed onto a vehicle component adjacent to the mount portion, in which a rough surface portion made of a molding material composed of the following constituents (a) to (c),

(a) olefin thermoplastic elastomer in which a content ratio of polyolefin resin as a hard segment is 50 mass % or more as a whole, (b) solid particles having an average particle diameter in a range from 1 to 100 μm, and (c) liquid lubricant at room temperatures, is provided at least in a part of the pressure contact portion where the resin molding member can directly make contact with the vehicle component, and in which the rough surface portion has a surface formed in a corrugation state, and is formed with a number of small projections with the solid particles on a corrugated face of the rough surface portion.

(2) The long resin molding member according to the item (1), characterized in that the pressure contact portion is pressed onto the glass window pane.

(3) The long resin molding member according to the item (2), characterized in that the pressure contact portion is pressed onto the moving glass window pane.

(4) The long resin molding member according to the item (1), characterized in that the pressure contact portion is pressed onto a vehicle body panel.

(5) The long resin molding member according to the item (4), characterized in that the pressure contact portion is pressed onto the vehicle body panel and mounted on the movable mount portion.

The specific examples of the invention have been described above in detail only for illustrative purpose, but may not limit the scope of the invention as defined in the claims. Various modifications or variations of the specific examples as illustrated may be included in the techniques as disclosed in the claims.

Also, the technical elements as described in this specification or drawings exhibit the technical utility singly or in combination, but may not be limited to the combination of elements as defined in the claims at the time of application. Also, the techniques as illustrated in this specification or drawings may accomplish a plurality of purposes at the same time, and only one of the purposes may be achieved to exhibit the technical utility.

1. A long weather strip, comprising:
an attach portion attachable along a window frame for vehicle; and
a lip portion for sealing a glass window pane for vehicle, the lip portion protruding from the attach portion toward the glass window pane to be in contact therewith, the glass window pane movable within the window frame;
wherein the lip portion is resiliently pressed onto the surface of the glass window pane;
the lip portion includes a rough surface portion made of a molding material comprising the following (a) to (c):
(a) olefin thermoplastic elastomer in which a content ratio of polyolefin resin as a hard segment is 50 mass % or more as a whole,
(b) solid particles having an average particle diameter in a range from 1 to 100 μm, and
(c) liquid lubricant at room temperatures, the rough surface portion provided at least in a part of the lip portion that is pressed onto a face of the glass window pane; and
the rough surface portion has a surface that is formed in a corrugation state, and is formed with a number of small projections with the solid particles on a corrugated face of the rough surface portion.

2. The weather strip according to claim 1, wherein the olefin thermoplastic elastomer contains a hard segment made of polypropylene resin, and a soft segment made of ethylene-propylene-diene copolymer.

3. The weather strip according to claim 1, wherein the lubricant includes silicone oil.

4. The weather strip according to claim 1, wherein the solid particle is a material not melted at the time of molding the rough surface portion.

5. The weather strip according to claims 1, wherein the solid particle includes at least one kind of spherical particle selected from a group consisting of silicone resin particle, glass bead, glass balloon, silica particle, polymethyl methacrylate resin particle, and polyether-ether-ketone resin particle.

6. The weather strip according to claim 1, wherein the rough surface portion contains 1 to 20 mass parts of the solid particles and 1 to 20 mass parts of the lubricant to 100 mass parts of the olefin thermoplastic elastomer.

7. The weather strip according to claim 1, further comprising:
a long resin main portion made of a molding material containing olefin thermoplastic elastomer having a lower hardness than the olefin thermoplastic elastomer of (a);
wherein the rough surface portion is provided at least in a part on the surface of the resin main portion.

8. The weather strip according to claim 7,
wherein the resin main portion and the rough surface portion have miscibility, and are welded at a boundary therebetween.

9. The weather strip according to claim 7,
wherein the rough surface portion is formed in a layer, being from 10 to 100 μm in an average thickness.

10. The weather strip according to claim 7,
wherein the rough surface portion has a corrugated face that is formed with a plurality of line-like protruded portions extending longitudinally and being spaced at an interval in the width direction, the small projections being formed on the surface of the protruded portion.

11. The weather strip according to claim 7,
wherein the rough surface portion is formed like a longitudinally extending line, and a plurality of line rough surface portions are spaced at an interval in the width direction.

12. The weather strip according to claim 7, further comprising:
a groove for guiding the glass window pane in contact with a peripheral edge thereof;
wherein the groove includes a base portion making up a bottom of the groove, and side wall portions rising from both ends of the base portion in the width direction and making up the side walls of the groove; and
the resin main portion includes the base portion, the side wall portions, and the lip portions integrally.

13. The weather strip according to claim 12, wherein the rough surface portion is further provided on a surface inside the groove in the base portion.

14. The weather strip according to claim 12, wherein the rough surface portion is further provided on at least one of the surfaces inside the groove in the side wall portion and a back face of the lip portion opposite the surface.

15. The weather strip according to claim 1,
wherein the weather strip is formed as a belt molding that is attached along an edge of the window frame.

16. A weather strip assembly for vehicle comprising:
at least two long weather strips for vehicle mounted along a window frame for vehicle and having a groove for guiding a glass window pane in contact with a peripheral edge of the glass window pane movable within the window frame; and
a joint portion for connecting the longitudinal terminals of the weather strips;
wherein each of the weather strips comprises a base portion making up a bottom of the groove, the side wall portions rising from both ends of the base portion in the width direction and making up the side walls of the groove, and the lip portions overhanging inside the groove from the side wall portions and resiliently pressed onto a surface of the glass window pane;
at least one of the weather strips having a rough surface portion made of a molding material containing the following (a) to (c):
(a) olefin thermoplastic elastomer in which a content ratio of polyolefin resin as a hard segment is 50 mass % or more as a whole,
(b) solid particles having an average particle diameter in a range from 1 to 100 μm, and
(c) liquid lubricant at room temperatures, the rough surface portion is provided in a part of the lip portion pressed onto the surface of the glass window pane; and
the rough surface portion has a surface formed in a corrugation state, and is formed with a number of small projections with the solid particles on a corrugated face of the rough surface portion.

17. The weather strip assembly according to claim 16,
wherein the at least one of the weather strips is a glass run channel further including a rough surface portion in at least one part of
(a) a surface inside the groove in the base portion,
(b) a surface inside the groove in the side wall portion, and
(c) a back face of the lip portion opposed to the surface inside the groove in the side wall portion.

18. A method for manufacturing a long weather strip for vehicle, wherein the weather strip includes: an attach portion attachable along a window frame for vehicle, and a lip portion for sealing a glass window pane for vehicle, the lip portion protruding from the attach portion toward the glass window pane to be in contact therewith, the glass window pane movable within the window frame; and the lip portion has a rough surface portion provided at least in a part of the lip portion pressed onto a face of the glass window pane; the method comprising:
heating and melting a molding material for formation of the rough surface portion, the molding material containing the following (a) to (c);
(a) olefin thermoplastic elastomer in which a content ratio of polyolefin resin as hard segment is 50 mass % or more as a whole,
(b) solid particles having an average particle diameter in a range from 1 to 100 μm, and
(c) liquid lubricant at room temperatures; and
extruding the melted molding material from a resin extrusion mold, thereby forming the rough surface portion having a surface formed in a corrugation state and formed with a number of small projections with the solid particles on a corrugated face thereof.

19. The manufacturing method according to claim 18,
wherein the rough surface portion is formed at least in a part on the surface of the long resin main portion;
the step of heating and melting includes heating and melting the molding material for formation of the rough surface portion and a molding material for formation of the resin main portion; and
the step of extruding includes extruding the molten molding materials from the resin extrusion mold at the same time, thereby forming the resin main portion and the rough surface portion.

20. The manufacturing method according to claim 18,
wherein the extruding step includes extruding the molten molding material for formation of the rough surface together with a long preformed main portion from the resin extrusion mold, thereby forming the rough surface portion at least in a part on the surface of the long preformed main portion.
